(19) United States
(12) Patent Application Publication
(10) Pub. No.: US 2009/0160365 A1
(43) Pub. Date: Jun. 25, 2009

(54) Apparatus Having Supply Voltage Adaptive Light Emitting Component Circuitry And Method Of Controlling

(76) Inventor: Paavo Niemitalo, Haukipudas Kello (FI)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 12/300,234

(22) PCT Filed: May 10, 2006
(86) PCT No.: PCT/IB06/01216

§ 371 Date: Dec. 31, 2008

(51) Int. Cl. H05B 37/02; H05B 39/04

(52) U.S. Cl. 315/294; 315/312

(57) ABSTRACT

A portable electric apparatus enabled for light irradiation substantially independent of a supply voltage and a method for controlling the light irradiation is provided. The device comprises a power source with a wide total operating voltage variation range, a voltage sensor adapted for generating one or more switch control signals, a plurality of light irradiating components, and at least one switch operable in accordance with the switch control signals. The voltage sensor is configured to generate the switch control signals in dependence of a current supply voltage provided by the power source and several voltage variation sub-ranges defined in relation to the total operating voltage variation range. The switch operable upon the switch control signals is arranged to operatively connect a first number of several irradiating components in series, when the current supply voltage is within an upper sub-range and to operatively connect a second number of one or more irradiating components in parallel, when the current supply voltage is within a lower sub-range.

The present invention relates to in general to an apparatus having substantially supply voltage independent light emitting luminosity. In particular, the present invention relates to an apparatus capable for IR data communications with substantially constant luminosity, while the apparatus is powered by a source having wide supply voltage variation characteristics.

Today's and future mobile or portable electronic consumer (CE) devices such as cellular telephones, personal digital assistants (PDAs), portable gaming devices, and portable processing devices such as notebook sized computers are typically powered by rechargeable accumulators. In the field of rechargeable accumulator technology, there are known several principle types of accumulators. Typical types of accumulators employed today for powering portable electronic devices are denoted in accordance with their cell chemistries including for instance nickel cadmium (NiCd), nickel metal hydride (NiMH), lithium ion (Li-ion), and Lithium ion polymer (Li-ion polymer).

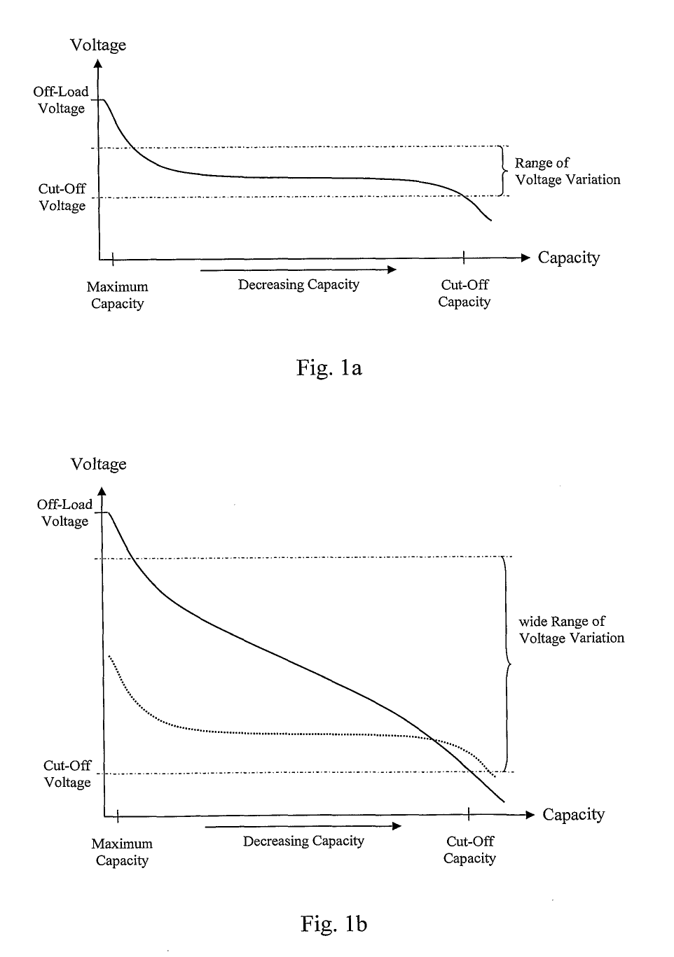

In common, such accumulators, also denoted secondary (electrolytic) cells in contrast to non-rechargeable batteries called primary (electrolytic) cells, have a flat voltage variation in accordance with the charging state/current charging capacity and the initial operation mode. Reference should be given to FIG. 1a, which illustrates exemplarily a characteristic voltage provided by an accumulator in dependence of the capacity of the accumulator. This characteristic progress of voltage in dependence of the accumulator capacity applies to all accumulators conventionally used in portable electronic consumer (CE) devices.

The variation of the operating voltage of an accumulator is predetermined by the chemistry of accumulator employed. For instance, a lithium ion (Li-ion) accumulator has a nominal voltage of about 3.7 to 3.6 volts, a maximum off-load voltage of about 4.2 volts, a cut-off voltage of about 3.0 volts, and a final discharging voltage of about 2.5 volts. The operating voltage typically ranges from approximately 3.6 volts to 3.0 volts (in dependence of the capacity). This means that the operating voltage varies merely slightly. The variation voltage range has a ratio of about 1:1.2. It should be noted that the range of the operating voltage may also depend on discharge current, operating temperature, number of charge cycles, age of the accumulator, and/or further conditions.

Current and future portable electronic consumer (CE) devices powered by accumulators have a limited operating period due to the limited capacity of the accumulators employed. Great efforts have been made and developments are still under progress to limit and/or reduce the power consumption of such portable electronic consumer (CE) devices. However, rapid increase in the functionality of such devices, typically in consequence to requests by consumers for improved and/or extended functionality, contradicts such efforts. This means that due to market requirements and market development in the field of portable electronic consumer (CE) devices, components increase in their complexity and therefore, their power consumption.

Hence, the field of accumulator technology is also addressed by the aforementioned market development. Improved capacity of accumulators enables the implementation of components having increased power consumption. In future, such high capacity accumulators and/or batteries being based on improved chemistry will be available as power supply powering portable electronic consumer (CE) devices. Although, the improved capacity of accumulator enables to overcome today's primary disadvantage of short operation periods of portable electronic devices, the increase of capacity will be obtained at the expense of a wide variation of the operating voltage. In particular, it has to be expected that the (operating) voltage variation range can be for instance at a ratio of approximately 1:2 or even more extreme.

The components of portable electronic devices have to be adapted to such a voltage variation ratio. Typical methods and devices, which are used today with power supplied having a ratio of about 1:1.2, may not be applicable or may only be applicable at the price of increased power dissipation, which contradicts the efforts made to reduce power consumption.

One component, which may suffer from wide voltage variation range, is an infrared (IR) transceiver and in particular an infrared (IR) transmitter (being for instance part thereof). In the field of portable electronic devices, IR transceivers compatible with the IrDA (Infrared Data Association) standard are typically employed. The operation of the transmitting infrared light emitting diode (IR LED) requires conventionally a specific supply voltage, because of constraints concerning the irradiated power of the irradiating IR LED. The specific supply voltage should have a considerable narrow supply voltage variation range. Typical IrDA compatible modules have built in constant current IR transmitter (TX) drivers, which are keyed by a transmission (TX) data stream (comprising logical high and logical low electric signals). The current is typically independent of a supply voltage in the specific voltage range of the irradiating IR LED. Usually the supply voltage selected for being sufficiently high enough and a part of the voltage drop at the constant current driver is moved to one or more additional, external, serial resistors. This measure is taken to reduce the internal power dissipation of the IrDA module and for safety reasons in case of a shorted IR transmitter (TX) driver conventionally implemented by the means of a transistor. Those skilled in the art will appreciate that this conventional approach leads to a reduced communication performance on the low end of voltage of the power source and poor power efficiency on high voltages provided by the power source.

Therefore, it is a need to provide power saving components for portable electronic devices. In particular, there is a need to provide portable electronic devices equipped with a power supply having a wide operating voltage range with light emitting components irradiating substantially independent of a current supply voltage at high power efficiency.

The object of the present invention is solved by the features of the independent claims accompanying.

According to another aspect of the present invention, a portable electric apparatus enabled for light irradiation substantially independent of a supply voltage is provided. The device comprises a power source with a wide total operating voltage variation range, a voltage sensor adapted for generating one or more switch control signals, a plurality of light irradiating components, and at least one switch operable in accordance with the switch control signals. The voltage sensor is configured to generate the switch control signals in dependence of a current supply voltage provided by the power source and several voltage variation sub-ranges (or voltage variation sub-domains) defined in relation to the total operating voltage variation range (or total voltage variation domain). The switch operable upon the switch control signals is arranged to operatively connect a first number of several irradiating components in series, when the current supply voltage is within an upper sub-range and to operatively connect a second number of one or more irradiating components in parallel or individually, when the current supply voltage is within a lower sub-range.

Each of the first and second number of irradiating components may comprise one or several irradiating components. In particular, the first number comprises two or more irradiating components and the second number comprises one or more irradiating components. It should be noted that in case the second number comprises one irradiating components, the connection in parallel should be understood as an individual operation of the irradiating component.

According to an embodiment of the present invention, one or more power generators are comprised, each of which is adapted for settable control over one or more currents conducted through the IR irradiating components.

According to an embodiment of the present invention, the voltage sensor, which is adapted for generating one or more switch control signals, is configured to generate the switch control signals in accordance with a control hysteresis to prevent undefined switching states.

According to an embodiment of the present invention, the plurality of irradiating components comprises two irradiating components, which are operable in series in case of the current supply voltage being within the upper sub-range. One of the two irradiating components thereof is solely operable in case of the current supply voltage being within the lower sub-range. The upper sub-range and the lower sub-range in total represents the total operating voltage variation range.

According to an embodiment of the present invention, the power generators are adapted for settable control over the currents in dependence of the current supply voltage.

According to an embodiment of the present invention, the power generators are configured by the means of the settable control to enable the substantially constant total luminosity independent from the current supply voltage of the power source.

According to an embodiment of the present invention, the irradiating components are light emitting diodes (LEDs) and in particular, the irradiating components are infrared light emitting diodes (IR LEDs)

According to an embodiment of the present invention, the power source comprises one or more high energy density accumulator and/or one or more high energy density batteries.

According to an embodiment of the present invention, the device further comprises a processing unit (CPU/MPU) and at least an IR transmitter enabling for IR communications. The irradiating components are infrared light emitting components including especially infrared light emitting diodes (IR LEDs).

According to an aspect of the present invention, a method is provided. A current supply voltage is sensed by the means of a voltage sensor. The supply voltage is provided by a power source with a wide total operating voltage variation range. The power source comprises in particular one or more high energy density accumulators and/or one or more high energy density batteries. One or more switch control signals are generated by the means of a voltage sensor in dependence of the sensed current supply voltage and several voltage variation sub-ranges defined in relation to the total operating voltage variation range. A least one switch is actuated in accordance with the switch control signals in that a first number of light irradiating components is operatively connected in series, when the current supply voltage is within an upper sub-range; and a second number of light irradiating components is operatively connected in parallel or individually, when the current supply voltage is within a lower sub-range. The irradiating components are provided to generate light irradiation substantially independent of the supply voltage of the irradiating components.

According to an embodiment of the present invention, one or more currents conducted through the IR irradiating components are controlled by the means of one or more power generators.

According to an embodiment of the present invention, the one or more switch control signals are generated in accordance with a control hysteresis to prevent undefined switching states.

According to an embodiment of the present invention, two irradiating components are operatively connected in series, when the current supply voltage is within the upper sub-range and one irradiating component of the two IR irradiating components is operatively connected, when the current supply voltage is within a lower sub-range. The upper sub-range and the lower sub-range in total represent the total operating voltage variation range.

According to an embodiment of the present invention, one or more currents conducted through the IR irradiating components are settably controlled in dependence of the current supply voltage. The settable control is exercised by settable, predetermined, or definable current target values in dependence of the current supply voltage.

According to an embodiment of the present invention, The power generators exercising the control over the currents in dependence of the current supply voltage is settably controllable to obtain a total luminosity of light irradiation substantially independent from the current supply voltage of the power source.

According to an embodiment of the present invention, the method is operated by a portable electric device having a processing unit (CPU/MPU 110) and being equipped with at least an IR transmitter enabling for IR communications. The irradiating components are infrared light emitting components and in particular infrared light emitting diodes (IR LEDs).

In the drawings,

FIG. 1a shows schematically characteristics of an accumulator voltage in dependence of the accumulator capacity as being known from conventional accumulators having a narrow voltage variation range;

FIG. 1b shows schematically characteristics of an accumulator voltage in dependence of the accumulator capacity as being known from future, high energy density accumulators having a wide voltage variation range;

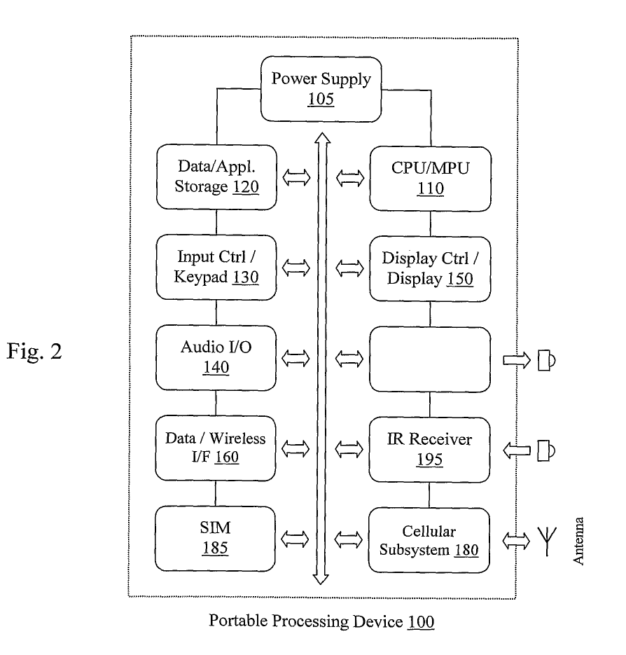

FIG. 2 depicts schematically components of a CE device according to an embodiment of the present invention;

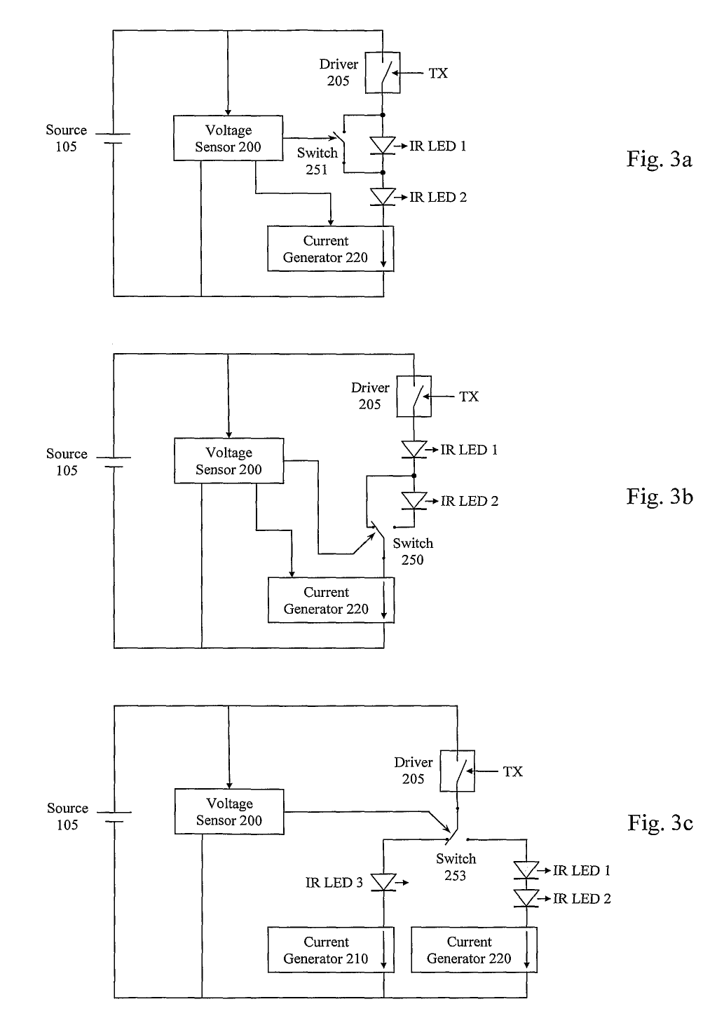

FIGS. 3a to 3c depict schematically circuitries of an IR signal transmitter according to embodiments of the present invention;

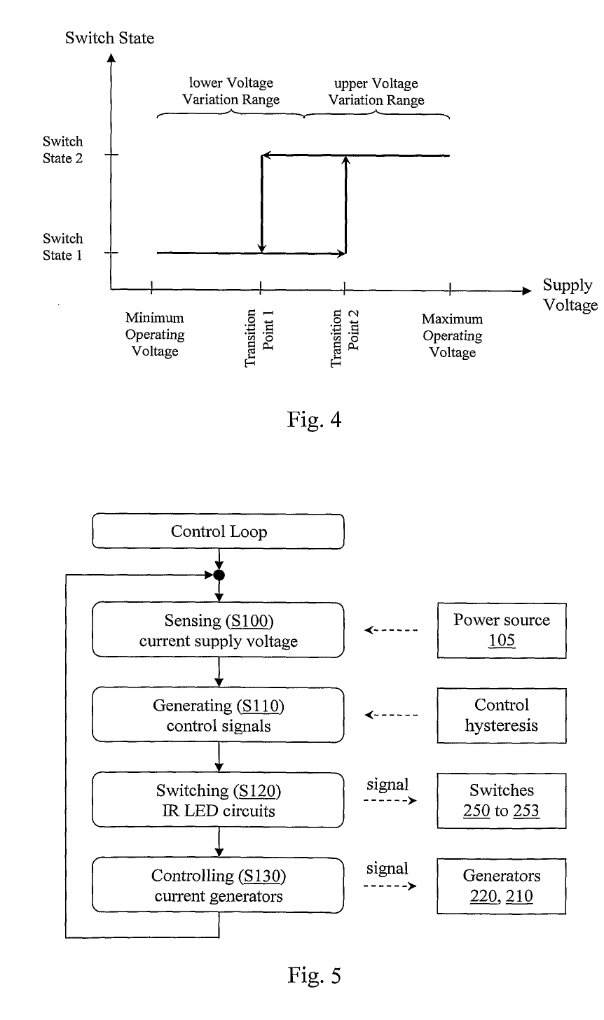

FIG. 4 depicts schematically a control hysteresis according to an embodiment of the present invention; and

FIG. 5 depicting a schematic flow chart illustrating control loop according to an embodiment of the present invention.

While the invention is susceptible to embodiment in many different forms, there are shown in the drawings and will be described herein in detail specific embodiments thereof with the understanding that the present disclosure is to be considered as an example of the principles of the invention and is not limited to any specific embodiments described.

FIG. 2 shows a schematic block illustration of components of a portable electronic device embodied as a portable cellular communication enabled processing terminal 100 by the way of illustration. The electronic device 100 exemplarily represents any kind of processing device or processing terminal device applicable with the present invention. It should be understood that the present invention is neither limited to the illustrated device 100 nor to any other specific kind of processing terminal or device.

As aforementioned, the illustrated device 100 is embodied as a cellular communication enabled portable terminal device being capable for IR communications. In particular, the device 100 is embodied as a processor-based or micro-controller based system comprising exemplarily inter alia a central processing unit (CPU) and a mobile processing unit (MPU) 110, respectively, a data and application storage 120, user interface input/output means including typically audio input/output (I/O) means 140 (conventionally a microphone and a loudspeaker), keys, keypad and/or keyboard with key input controller (Ctrl) 130. and a display with display controller (Ctrl) 150, at least an IR transmitter 190, preferably an IR receiver 195, an optional cellular communication means including cellular radio frequency interface (I/F) 180 with correspondingly adapted RF antenna (outlined) and subscriber identification module (SIM) 185, and optionally one or more further data interfaces such as a (local) wireless and/or wired data interface (I/F) 160. The IR transmitter 190 and IR receiver 195, depicted for the way of illustration, may be implemented by the means of an IR transceiver integrating both functionalities.

The operation of the terminal device 100 is controlled by the central processing unit (CPU)/mobile processing unit (MPU) 110 typically on the basis of an operating system or basic controlling application, which controls the functions, features and functionality of the terminal device 100 by offering their usage to the user thereof. The function, features, and functionality of the device 100 are enabled by the means of hardware and/or software components. Such hardware components, which will be exemplarily described below, are enabled for communication with the processing unit (CPU/MPU) 110 through one or more general and/or specific data communication connections and/or busses (serial or parallel). Software components are typically stored in the data and application storage 120, which may comprise any random access memory (RAM), any a read-only memory (ROM) and/or any combination thereof. It should be noted that several memory technologies are applicable to realize RAM and/or ROM storages. In general, software components include a list of instructions to be executed by the processing unit (CPU/MPU) 110 in consequence of which a processing result may be (audibly and/or visibly) presented to the user and/or one or more other (hardware and/or software) components are controlled and/or instructed to operate.

The display and display controller (Ctrl) 150 are typically controlled by the processing unit (CPU/MPU) 110 and provide information for the user including especially a (graphical) user interface (UI) allowing the user to make use of the functions, features and functionality of the electronic device 100. The keypad and keypad controller (Ctrl) 130 are provided to enable the user inputting information. The information input via the keypad is conventionally supplied by the keypad controller (Ctrl) to the processing unit (CPU/MPU) 110, which may be instructed and/or controlled in accordance with the input information. The audio input/output (I/O) means 140 includes at least a speaker for reproducing an audio signal and a microphone for recording an audio signal. The processing unit (CPU/MPU) 110 can control conversion of audio data to audio output signals and the conversion of audio input signals into audio data, where for instance the audio data have a suitable format for transmission and storing. The audio signal conversion of digital audio to audio signals and vice versa is conventionally supported by digital-to-analog and analog-to-digital circuitry e.g. implemented on the basis of a digital signal processor (DSP, not shown).

The keypad operable by the user for input comprises for instance alphanumeric keys and telephony specific keys such as known from ITU-T keypads, one or more soft keys having context specific input functionalities, a scroll-key (up/down and/or right/left and/or any combination thereof for moving a cursor in the display or browsing through the user interface (UI), a four-way button, an eight-way button, a joystick or/and a like controller.

The device 100 according to a specific embodiment illustrated in FIG. 2 includes the optional cellular communication subsystem 180 coupled to the radio frequency antenna (outlined) and operable with the subscriber identification module (SIM) 185. The cellular communication subsystem 180 may be also designed as cellular (communication) interface (I/F). The cellular communication subsystem 180 provides for an over-the-air interface operable for cellular data and/or voice communications with a corresponding base station (BTS) of a radio access network (RAN) of a public land mobile network (PLMN). The wireless and/or wired data interface (I/F) 160 is depicted exemplarily and should be understood as representing one or more of such data interfaces. A large number of different wireless and/or wired communication standards as well as proprietary communication techniques are available today.

The components and modules illustrated in FIG. 2 may be integrated in the electronic device 100 as separate, individual modules, or in any combination thereof. Preferably, one or more components and modules of the electronic device 100 may be integrated with the processing unit (CPU/MPU) forming a system on a chip (SoC). Such system on a chip (SoC) integrates preferably all components of a computer system into a single chip. A SoC may contain digital, analog, mixed-signal, and also often radio-frequency functions. A typical application is in the area of embedded systems and portable systems, which are constructed especially to size and power consumption constraints. Such a typical SoC consists of a number of integrated circuits that perform different tasks. These may include one or more components comprising microprocessor (CPU/MPU), memory (RAM: random access memory, ROM: read-only memory), one or more UARTs (universal asynchronous receiver-transmitter), one or more serial/parallel/network ports, DMA (direct memory access) controller chips, GPU (graphic processing unit), DSP (digital signal processor) etc. The recent improvements in semiconductor technology have allowed VLSI (Very-Large-Scale Integration) integrated circuits to grow in complexity, making it possible to integrate all components of a system in a single chip.

Typical alternative portable processing systems or devices may include personal digital assistants (PDAs), hand-held computers, notebooks, so-called smart phones (cellular phone with improved computational and storage capacity allowing for carrying out one or more sophisticated and complex applications), electronic gaming devices and any kind of portable electronic device. Hence, it should be understood that, although the aforementioned processing device 100 embodied as a portable processing device enabled for cellular communication, the present invention is not limited to any specific implementation of a processing device. Rather, any processing device capable for IR data transmission and in particular for IR data communications may be employed with the general concept of the present invention. The implementation of such typical micro-processor based devices capable for IR communication (i.e. at least IR transmission) is well known in the art.

One major standard in the field of IR data communications is the IRDA (Infrared Data Association) standard. In general, an IrDA (Infrared Data Association) conform transceiver broadcasts data by the means of infrared light irradiation, which carries the data to be transmitted on the basis of pulse modulation techniques. Typical data transmission rates, which are known from IrDA standard fall into categories: SIR, MIR, FIR, and VFIR. Serial Infrared (SIR) transmission rate supports transmission rates available at the serial RS-232 port (typically 9600 bit/s, 19.2 Kbit/s, 38.4 Kbit/s, 57.6 Kbit/s, and 115.2 Kbit/s). MIR (Medium Infrared) is not standardized, but refers usually to speeds of 0.576 Mbit/s and 1.152 Mbit/s. Fast Infrared (FIR) is deemed an obsolete term by the IrDA physical specification, but is nonetheless in common usage to denote transmission rate at 4 Mbit/s. FIR conventionally refers to all transmission rates above SIR. However, different encoding techniques are typically applicable with MIR and FIR, and different techniques are used to frame MIR and FIR packets. VFIR (Very Fast Infrared) supports transmission rates up to 16 Mbit/s. There are infrared transceivers available, which operate from 9.6 Kbit/s to 16 Mbit/s. UFIR (Ultra Fast Infrared) protocol that will provide transmission rates up to 100 Mbit/s is currently under development. Different modulation schemes are used in the field of IR communication. Known and typically used modulation schemes are Bi Phase Coding, Pulse Distance Coding, and Pulse Width Coding. However, it should be noted that the aforementioned specifications concerning the IrDA standard are described for the sake of completeness and the present invention should not be understood as being limited to any of these specifications.

As briefly summarized with reference to the background art, the operation of infrared light emitting diodes (IR LEDs) requires adaptation to the characteristics of the power source supplying the IR LEDs in accordance with the characteristics of the IR LEDs. In particular, the supply voltage of the IR LEDs has to be adjusted by transforming into a substantially steady supply voltage of operation. Such an adjustment is conventionally obtained by the means of one or more serial resistors connected to an IR LED. The objective of the adjustment primarily concerns a main constraint of substantially supply voltage independent luminosity of the irradiated infrared light. This means, when using accumulators and/or batteries as power source, the variation range of the supply voltage provided thereby in dependence of their capacity has to be considered. The adjustment of the resistor characteristics has to be made in view of the maximum supply voltage provided by the accumulators and/or batteries. The maximum voltage is conventionally supplied, when the accumulators and/or batteries have their maximum capacity stored. With decreasing stored capacity, the supply voltage of the accumulators and/or batteries decrease and the adjustment of the resistors characteristics mismatch. This results conventionally in a reduced luminosity of the infrared irradiation of the IR LED. However, it should also be considered that each serial resistor (connected upstream or downstream) for resistance adjustment dissipates energy and contributes to the overall power consumption of the device. Rather, a reduction of energy dissipation is a main aspect and any unnecessary and avoidable power dissipation should intended to be prevented. Moreover, the use of power sources having a wide voltage variation range would require adjustment of serial resistors such that the operation of the IR LED at low supply voltages is ensured. Consequently, the energy dissipation at high supply voltages is correspondingly high and in view of the power consumption and economic aspects not acceptable.

Another more complex approach may comprise a stabilized or regulated power source conventionally obtained by the implementation of an additional voltage regulator or voltage stabilizer, which allows the implementation of an IR LED having matching characteristics. However, voltage regulator and/or voltage stabilizer are expensive components. The power output of such voltage regulators and/or voltage stabilizers has to be adapted to the power required by components, which necessarily require a stabilized or regulated power supply. However, cost efficient and economic linear voltage regulators or voltage stabilizers are not energy efficient and dissipate heat. Lacking energy efficiency contradicts any energy saving efforts. The heat dissipation causes an additional thermal issue, which is especially problematic in small form factor devices and miniature-sized designs having constricted heart dissipation area. More sophisticated switched voltage regulators or voltage stabilizers overcome the poor energy efficiency of linear ones but are relatively expensive components, which contradicts conventionally the requirements of mass production typically characterized by profit margins. It is immediately apparent to those skilled in the art that the aforementioned disadvantages are likewise relevant for high energy density power sources having a wide voltage variation range.

The basic concept of the present invention enables to overcome the aforementioned disadvantages in an economic way and enables an efficient implementation operable with high energy density power sources having a wide voltage variation range.

The basic concept of the present invention will be described on the basis of embodiments depicted in FIGS. 3a to 3c and described below with reference thereto. It should be noted that the present invention should not be understood as being limited to any of the specific embodiments described for the sake of illustration.

With reference to FIG. 3a, a first embodiment of the present invention is illustrated. The exemplary circuitry illustrated in FIG. 3a should be understood as illustrating components of the portable electronic device 100 illustrated in FIG. 2 and described above with reference thereto, on the basis of which components the basic concept of the invention should be enlightened, but without being limited thereto. The circuitry of FIG. 3a according to an embodiment of the present invention comprises a power source 105, which has a wide voltage variation range. For instance, the voltage variation range of the power source 105 may be in a range form approximately 5 volts to 2.0 volts, i.e. the ratio thereof as defined above is approximately 1:2.5. The power source 105 may be a high power density accumulator or battery.

The circuitry comprises further a driver 205, which is supplied with a data transmission signal TX. The transmission data signal TX is intended for switching or actuating the infrared irradiation of the IR transmitter 190. The signal TX may be provided by a modulator (not shown) and the TX signal may be generated for instance in accordance with any of the aforementioned modulation technologies available in the field of IR communications. The generation of the signal TX is out of the scope of the present invention and is well known by those skilled in the art in the field of IR communications and IR transmitter technology. Hence, a detailed description thereof is omitted. In general, the transmission data signal TX is a data signal stream comprising electrical signals (e.g. including logical high and logical low signals), which enable to key or modulate the supply circuit of the infrared light emitting diodes (IR LEDs). The driver 205 may be a transistor, which switches or modulates the supply current in response to the transmission data signal TX comprising the data signal stream. The levels of the individual electrical signals of the data signal stream are adapted to circuitry logics used for implementation (such as any CMOS logics). Typically, two different electrical signals, which may be also patterns or waveforms, are implemented, which represent the bits “0” and “1”.

The circuitry of FIG. 3a comprises furthermore, a voltage sensor 200, a first current generator 220, and a switch 251 operable with a switching signal generated by the voltage sensor 200.

According to a general embodiment of the present invention, two or more infrared light emitting diodes (IR LEDs) are provided, which are operable to irradiate infrared signals, on the basis of which IR communications is for instance performed with a corresponding IR receiver having at least one infrared sensor adapted for detecting such infrared signals irradiated.

The voltage sensor 200 is adapted to sense the supply voltage of the power source 105 and is applicable to switch at least one of the IR LEDs in dependence of the sensed supply voltage. In more detail, the voltage sensor 200 is operable to switch between one IR LED, several IR LEDs connected in parallel, several IR LEDs in series and/or in general any arrangement of IR LEDs connected in parallel and in series. In the following, reference will be given to an IR LED circuitry in general, which comprise a plurality of IR LEDs. By the means of one or more switching components, such as switches, toggle switches, matrix switches and/or other devices capable for switching electrical connections, the electrical connection between one or more IR LEDs of the arrangement is switchably implemented. Each arrangement of the switchable connections of IR LEDs should be designated IR LED circuit. This means that, upon switching, the IR LED circuits may comprise for instance one IR LED of the IR LED circuitry, several IR LEDs of the IR LED circuitry connected in series, several IR LEDs of the IR LED circuitry connected in parallel, and/or any combination of the IR LEDs connected in parallel and series. It should be noted that one or more IR LEDs of the IR LED circuitry may be comprised by one or more different IR LED circuits.

As aforementioned, it is one main constraint to have the luminosity of the IR LED independent of the supply voltage of the power source 105. Assuming one IR LED, a predefined supply voltage as well as current has to be supplied thereto to obtain a desired luminosity. The predefined supply voltage as well as current can be derived from the characteristics of the IR LED.

Further assuming serially connected IR LEDs, which should for instance have the same characteristics of that one aforementioned, the required supply voltage is lower to obtain the substantially same desired luminosity. That means the serially connected IR LEDs have the substantially same luminosity in comparison with the luminosity of the individual IR LED described above.

Further assuming parallel connected IR LEDs, which should for instance have the same characteristics of that one or those ones aforementioned, the required supply voltage is lower to obtain the substantially same desired luminosity. Though, the parallel connected IR LEDs have the substantially same luminosity in comparison with the luminosity of the individual IR LED described above. But, it should be noted that LEDs, in particular IR LEDs, are components with non-linear characteristics both regarding the voltage-to-current relationship and the voltage-to-luminosity relationship. The current-to-luminosity relationship has substantially relatively linear characteristics in particular in view of the aforementioned characteristics. This means that n-times of the luminosity can be achieved by either supplying n-times the current to a single LED or by supplying the current n-times to a number of n LEDs.

Those skilled in the art will appreciate that the aforementioned discussion is simplified for the sake of understanding of the principles of the invention. The invention should not be understood as being limited to these simplified illustrative embodiments. The discussion above presumes in particular simplified characteristics of IR LEDs. Skilled person will nevertheless appreciate that analytic and/or numeric methodologies are available, on the basis of which electrical properties of any IR LED circuits are derivable from the characteristics of the IR LEDs.

These general considerations may now be applied to the circuitry illustrated in FIG. 3a. For the sake of simplicity, the wide voltage variation range should be divided into an upper voltage range and a lower voltage range. With reference to the aforementioned example of a voltage variation range of the power source from approximately 5.0 volts to 2.0 volts, the upper voltage range may be for instance from about 5.0 volts to 3.2 volts and the lower voltage range may be for instance from about 3.2 volts to 2.0 volts. In particular, the voltage variation range of the power source ranges from approximately 4.6 volts to 2.3 volts. The uppermost voltage value may be achieved at the end of charging period and the lowermost voltage value may be achieved at an almost discharged condition of the power source. A substantial current may be supplied by the power source down to at least approximately 2.5 volts. However, an operation of the device 100 and in particular the circuitries illustrated in FIGS. 3a to 3b should be also enabled during charging of the power source by the means of an external power supply (not shown). During charging, such an external power supply supplies a charging voltage at a voltage level above the uppermost supply voltage of the power source. Hence, this voltage contribution (for instance about 0.5 volts, 1 volts, 1.5 volts, or any voltage values therebetween) should be considered when defining the total voltage variation range of the power source.

Those skilled in the art will appreciate on the basis of the aforementioned considerations that a connection in series of several IR LEDs, in particular two IR LEDs, is advantageous when the supply voltage of the power source is within the upper voltage range. In case that the supply voltage of the power source is within the lower voltage range, an operation of an individual IR LED or a connection in parallel of several IR LEDs is advantageous. The connection in series of the IR LEDs enables a matching of the characteristics of the connection in series to the supply voltage being within the upper voltage range, whereas the connection in parallel of IR LEDs and an individual IR LED enables a matching of the characteristics of thereof to the supply voltage being within the upper voltage range, respectively.

Moreover, several IR LEDs may be provided. The aforementioned connection in series, connection in parallel, and the individual IR LED may be obtained by changeable/switchable electrical connections of the IR LEDs and/or in-between the IR LEDs. In particular, one or more switches may be operable to obtain a connection in series of several IR LEDs, an operability of an individual IR LED and/or a connection in parallel of several IR LEDs, whereas the IR LEDs may be part of a common pool of IR LEDs.

For the sake of simplicity, FIG. 3a illustrates two IR LEDs. By the means of a switch 251, an operation of the IR LEDs connected in series and an operation of one IR LED of the totality of two IR LEDs can be obtained. The switch 251 is operable for by passing the IR LED 1. The switch 251 is actuated in response to a switching signal generated by the voltage sensor 200. In case the supply voltage of the power source is within the upper voltage range the IR LEDs 1, 2 are connected in series and otherwise, i.e. the supply voltage of the power source is within the lower voltage range, the one IR LED 1 (which is one IR LED 1 out of the aforementioned IR LEDs 1, 2 connected in series) is switched. At the same time, the power generator 220 is adjusted to provide the correct voltage/current to achieve a substantially identical luminosity.

In case IR LEDs are connected in series, an individual IR LED is operated, or IR LEDs are connected in parallel, one or more current generators may be provided, by the means of which the current conducted through the respective IR LED circuit is additionally adjustable. Such current generators can be for instance obtained by a power source and an adjustable resistor. In case of the supply voltage being within the upper voltage range and a connection in series of several IR LEDs (in particular two IR LEDs), the current conducted through this connection in series should be adjusted to a lower current level in comparison to a feeding of an individual IR LED, which is operated in case of the supply voltage being within the lower voltage range. For instance, the power generator 220 may be settable to supply a current up to 250 mA in case of the supply voltage being within the upper voltage variation range, whereas the power generator 220 may be settable to supply a current up to 500 mA in case of the supply voltage being within the lower voltage variation range. The power generator 220 may receive a control signal (not shown in FIG. 3a) from the voltage sensor 200, which indicates a current supply voltage of the power source. On the basis of this control signal, the power generator 220 is operable with adjusting the settable current supplied thereby. This means that with reference to the embodiment shown in FIG. 3a, the current is set/adjusted to “high” in case one (individual) IR LED 1 is driven and the current is set/adjusted to “low” in case the two serially connected IR LEDs 1, 2 are driven. The IR LED circuit is switched by the means of a switching signal generated by the voltage sensor 200 in response to the supply voltage sensed. The current is controlled by the current generator 220, which are operable in accordance with a control signal generated by the voltage sensor 200 in dependence of the supply voltage sensed. Though, the power generator 220 may be adjustably adapted to supply a current independent of the supply voltage, which current is adjustable in dependence of the supply voltage, the switched LED circuit, and/or voltage variation sub-range. The power generator 220 may be adapted to supply a substantially constant current adjustable in accordance with the aforementioned dependencies.

Those skilled in the art will appreciate that a main aspect of the embodiment of FIG. 3a is the current required for being conducted through the switchably selectable IR LED circuits; i.e. the one individually operated IR LED 1 and the serially connected, commonly operated IR LEDs 1 and 2. In case of the operation of the two IR LEDs connected in series, the required current is about 50% (half) of that current which is required when operating one (individual) IR LED when assuming a general constraint of substantially same luminous intensity (luminosity) of the total irradiation. This general consideration also applies to the embodiments described below.

The current generator 220 enables for substantially providing a constant luminosity of the IR LEDs independent from the supply voltage of the power source and the number and inter-connectivity of the one or more IR LEDs operated. Hence, those skilled in the art will appreciate on the basis of the aforementioned considerations that the basic inventive concept is operable with high energy density power sources having wide voltage variation ranges, provides significantly improved power efficiency in comparison with approaches of the state of the art, and enables economic and effective power management. With reference to FIG. 3a, the power generator 220 is operable to control the current through the connection in series of the IR LEDs as well as the power generator 220 is arranged to control the current through the individually operated IR LED, which is one or the IR LEDs connected in series in dependence of the switching position (or switching state) of the switch 251. Moreover, it should be also noted that the current generator 220 and the driver 205 are described as separate components for the sake of illustration and simplicity. The invention should not be understood as being limited thereto. Alternative embodiments of the invention may comprise one or more constant current drivers, which are adapted to enable the operation of both the current generator 220 and the driver 205. This consideration may also apply to the embodiments described below.

The voltage sensor 200 and/or further control components may be integrally provided with an IR module, which at least partly forms the IR transmitter or IR transceiver. Alternatively, the sensing operation of the aforementioned voltage sensor 200 may be performed by a controller of the electrical device, which controller provides one or more control lines to the IR module.

In order to prevent any undefined switching states, the voltage sensor 200 may apply a control hysteresis to generate the switching signal in dependence of the current supply voltage of the power source. Such a hysteresis curve is schematically depicted in FIG. 4. In case the supply voltage of the power supply drops from the maximum operating voltage and a predetermined and/or settable first transition point 1 is reached, the switching state changes from the first switching state 1, which indicates that the supply voltage is within the upper voltage range, to the second switching state 2, which indicate that the supply voltage is within the lower voltage range. In case the supply voltage varies about this first transition point 1, the switching state does not change. The transition of the switching state from the second switching state 2 to the first switching state 1 is performed only in case the supply voltage rises up to a second transition point 2, which corresponds to a higher voltage than the first transition point 1. The analogous behavior is obtained at the second switching state 2.

With reference to FIG. 3b, a second embodiment of the circuitry is illustrated. The considerations aforementioned apply analogously to this embodiment. In contrast to the above description, a toggle switch 250 is arranged, which switches between a connection in series of the two IR LEDs 1, 2 and the operation of the individual IR LED 1 thereof. The arrangement of the switch 250 is selected to connect the current generator either to one end of the serially connected IR LEDs and the connection point between the IR LEDs 1, 2. For detail about the arrangement thereof, reference should be given to FIGS. 3a and 3b. The switching position (or switching state) of the toggle switch 250 is under control of the voltage sensor 200, which operates the electrically actuatable toggle switch 250 by the means of an electric switching signal, which depends on the supply voltage and the one or more voltage ranges defined in the total voltage variation range of the power source 105.

With reference to the embodiment shown in FIG. 3b, the current conducted through the one or more switchably selected IR LEDs is set/adjusted to “high” in case one (individual) IR LED 1 is driven and the current is set/adjusted to “low” in case the two serially connected IR LEDs 1, 2 are driven. The IR LED circuit is switched by the means of a switching signal generated by the voltage sensor 200 in response to the supply voltage sensed. The current is controlled by the current generator 220, which is operable in accordance with a control signal generated by the voltage sensor 200 in dependence of the supply voltage sensed.

Electrically controlled switches such as switches 250, 251, and 253 (see below) controllable by an (electric) switching signal (supplied by the voltage sensor 200) are available and have typically electrical resistances in the range of a few ohms or even less such that the energy dissipation thereof can be neglected. Such switches may be provided separately in the circuitry, the switches may be integrated within the driver 205 of the one or more IR LEDs and/or integrally with one or more further components of the circuitry.

It should be further noted that IR LEDs may be provided as individual components, are available in the form of a package integrating a plurality thereof, or can be arranged on a single chip carrying a plurality thereof. In view of manufacturing constraints, IR LED packages or IR LED chips each integrating several IR LEDs can be economical advantageous in view of manufacturing effort and costs. In addition, driving circuitry and/or switches may be integrated in the same chip together with one or more LEDs or IR LED chip.

With reference to FIG. 3c, a third embodiment is illustrated, which comprises two IR LEDs connected in series and a separate IR LED. The (electrically controllable) toggle switch 253 is operable to switch either the two IR LEDs 1, 2 connected in series or the separate individual IR LED 3. Further, the considerations aforementioned apply analogously to this embodiment. Reference should be given thereto. In contrast to the circuitries described above, the embodiment of FIG. 3c comprises two current generators 220 and 210. The current generator 220 is adapted to control the current conducted through the serially connected IR LEDs 1, 2, whereas the current generator 210 is adapted to control the current conducted through the separate IR LED 3. Each of the current generators 220, 210 may likewise receive a control signal from the voltage sensor 200, which enables the current generators 220, 210 controlling the current conducted through the respective IR LED circuits connected thereto.

Those skilled in the art will understand that this embodiment may be alternatively implemented on the basis of one current generator controlling the current conducted through the serially connected IR LEDs 1, 2 as well as the separate IR LED 3. Moreover, the embodiments of FIGS. 3a and 3b may alternatively comprise two current generators, each of which been responsible for controlling the current conducted through one of the switched IR LED circuits (i.e. the individually switched IR LED 1 or the switched, serially connected IR LEDs 1, 2). Such implementations may require one or more additional switches or switched arranged at a different position in the circuitry.

With reference to the embodiment shown in FIG. 3c, the current conducted through the one or more switchably selected IR LEDs is set/adjusted to “high” in case one (individual) IR LED 3 is driven and the current is set/adjusted to “low” in case the two serially connected IR LEDs 1, 2 are driven. The IR LED circuit is switched by the means of a switching signal generated by the voltage sensor 200 in response to the supply voltage sensed. The current is controlled by the current generators 210 and 220. Herein the current generators 210 and 220 may be fixedly adapted to the aforementioned current setting. This means that the current generator 210 is adapted to enable a high current conducted through the one (individual) IR LED 3 and the current generator 220 is adapted to enable a low current conducted through the serially connected IR LEDs 1, 2. A control signal provided by the voltage sensor 200 to the current generator 210 and current generator 220 may be omitted in this case of several IR LED circuit specifically provided current generators. The voltage sensor 200 may merely supply the switching signal for operating the switch 253 to selectively switch between the both embodied IR LED circuits. It should be noted that high currents and low currents should be understood in relationship to each other.

With reference to FIG. 5, a schematic flow chart illustrating a control loop according to an embodiment of the present invention is depicted. The embodied control loop illustratively described the operation of the voltage sensor 200 and the interaction of signal supplied thereby to the actuatable switches 250 to 253 as well as the current generators 220, 210. The control loop is described with reference to operations, which are merely illustrative and not intended to limit the scope of the invention thereto.

In an operation S100, the current supply voltage of the power source 105 is sensed by the voltage sensor 200. The current supply voltage sensed generally varies with the current capacity of an accumulator or a battery comprised by the power source 105.

In an operation S110, at least the one or more switching signals are generated in dependence of the sensed current supply voltage and the supply voltage variation sub-range (voltage variation sub-domains). The voltage variation sub-ranges are defined in relation to the total voltage variation range (total voltage variation domain) of the power supply, within which the power supply is operable for powering the electric device.

The generation of at least the one or more switching signals should be performed in accordance with the control hysteresis illustrated in FIG. 4 and described in detail with reference thereto.

In an operation S120, the one or more switching signals are supplied to the one or more (electrically actuatable) switches, which are provided to enable switching between the IR LED circuits described above.

In an operation S130, further one or more control signals are supplied to the one or more current generators 220, 210. The current generators control the currents conducted through the IR LEDs circuits. The control signals enable a settable control to be exercised by the current generators 220, 210. This means that the current to be conducted is controlled in accordance with the one or more control signals supplied. The control signals may enable to define current target values for enabling control of conducted currents. The further one or more control signals may be generated in dependence of the sensed supply voltage, in accordance with the switching signal and/or dependence of any other (linear or non-linear) control curve including for instance one or more current control hysteresis.

Those skilled in the art will appreciate that the basic concept of the present invention described in detail above with reference to illustrating embodiments, which should not be understood as limiting the invention thereto, can be also applied in a more general context. For instance, the total voltage variation range of the power source may be divided into more than two sub ranges; i.e. the sub ranges applicable with the concept of the present invention should not be limited to an upper voltage variation range and a lower voltage variation range aforementioned. More than two sub-ranges may be defined; for instance an upper, a middle, and a lower voltage variation range or any other sub-range definitions. In accordance with the number of defined sub-ranges, a corresponding number of IR LED connection circuits each comprising one or more IR LEDs, being connected in series, in parallel, or in any combination thereof, should have to be provided. These IR LED connection circuits should be further switchably operable in dependence of a switching signal comprising a number of states corresponding to the number of sub-ranges and IR LED connection circuits, respectively. For example one or more (electrically operable) matrix switches may be implemented for selecting one of the IR LED connection circuits. Moreover, each of the IR LED connection circuits has arranged an associated power generator, which receives a control signal from the voltage sensor 200, in dependence of which the currents through the IR LEDs are adjustable and/or settable by the power generators. One or more power generators may also be responsible to exercise control over the current conducted through one or more IR LED connection circuits. Hence, the number of power generator may be less than the number of sub-ranges and IR LED connection circuits, respectively.

In particular, in case of a higher upper limit of the supply voltage (in comparison to the above example of 5 volts of a total range of approximately 5 volts to 2 volts) more than two IR LEDs may be provided in serial connection.

The hysteresis illustrated in FIG. 4 illustratively depicts a control hysteresis curve applicable for two sub-ranges of the voltage variation. The behavior of the switching signal in accordance with the control hysteresis curve has been described above in detail. Those skilled in the art will appreciate that a control hysteresis curve may be also provided in case of several sub-ranges. In general, two transition points have to be defined in relation to a common boundary of two adjacent sub-ranges, wherein one of the transition points should be defined below the common boundary and the other one thereof should be defined above the common boundary.

Those skilled in the art will appreciate that the present invention is not limited to any specific portable processing-enabled device. It should be understood that, although the description relates to infrared light emitting diodes (IR LEDs) as sources of light irradiation, the inventive concept is applicable with other light emitting sources of any technology and operable within any light frequency range; i.e. the concept of the present invention is applicable to such light emitting sources operable with portable/mobile electric devices, which underlay the same constraints of economic implementation, optimized (reduced) power efficiency, and/or optimized (reduced) heat dissipation. In particular, the inventive concept is applicable when luminosity substantially independent of a widely varying supply power is required or desired.

Those skilled in the art will also appreciate that according to embodiments of the present invention, the components may be arrange as integrated components with any other component of the portable electric device. In particular, the voltage sensor may be integrally provided with the power source. Moreover, the power generators are illustrated in view of their principle functionality. Different realizations and embodiments thereof should be understood as being part of the present invention.

1. An apparatus comprising at least:
a voltage sensor configured to generate one or more switch control signals;
at least one switch operable in accordance with said switch control signals;
wherein said voltage sensor is configured to generate said switch control signals in dependence of a current supply voltage provided by a power source and several voltage variation sub-ranges defined in relation to said total operating voltage variation range;
wherein said switch supplied with said switch control signals is arranged to operatively connect a first number of irradiating components in series, when said current supply voltage is within an upper sub-range and to operatively connect a second number of irradiating components in parallel or individually, when said current supply voltage is within a lower sub-range.

2. Apparatus according to claim 1, further comprising:
one or more power generators configured for settable control over one or more currents conducted through said irradiating components.

3. Apparatus according to claim 1, wherein said voltage sensor configured to generate one or more switch control signals is configured to generate said switch control signals in accordance with a control hysteresis to prevent undefined switching states.

4. Apparatus according to claim 1, wherein said plurality of irradiating components comprises two irradiating components, which are operable in series at said upper sub-range and one of the two irradiating components thereof is solely operable at said lower sub-range, wherein said upper sub-range and said lower sub-range in total represents the total operating voltage variation range.

5. Apparatus according to claim 2, wherein said power generators are configured for settable control over said currents in dependence of said current supply voltage.

6. Apparatus according to claim 5, wherein said power generators are configured by the means of said settable control to enable a substantially constant total luminosity independent of said current supply voltage of said power source.

7. Apparatus according to claim 1, wherein said irradiating components are light emitting diodes (LEDs).

8. Apparatus according to claim 1, wherein said power source comprises one or more high energy density accumulator and/or one or more high energy density batteries.

9. Apparatus according to claim 1, further comprising:
a processing unit (CPU/MPU); and
at least an IR transmitter enabling for IR communications;
wherein said irradiating components are infrared emitting components including infrared light emitting diodes (IR LEDs).

10. Method, comprising:
sensing a current supply voltage by the means of a voltage sensor,
wherein said supply voltage is provided by a power source having a wide total operating voltage variation range,
generating one or more switch control signals by the means of a voltage sensor in dependence of said sensed current supply voltage and several voltage variation sub-ranges defined in relation to said total operating voltage variation range;
actuating at least one switch in accordance with said switch control signals to operatively connect a first number of light irradiating components in series, when said current supply voltage is within an upper sub-range; and
operatively connect a second number of light irradiating components in parallel or individually, when said current supply voltage is within a lower sub-range,
wherein said irradiating components are provided to generate a light irradiation substantially independent of said supply voltage of said irradiating components.

11. Method according to claim 10, further comprising:
controlling one or more currents conducted through said irradiating components by the means of one or more power generators.

12. Method according to claim 10, comprising:
generating of said one or more switch control signals in accordance with a control hysteresis to prevent undefined switching states.

13. Method according to claim 10,
operatively connecting two irradiating components in series, when said current supply voltage is within said upper sub-range; and
operatively connecting solely one of said two irradiating components, when said current supply voltage is within a lower sub-range,
wherein said upper sub-range and said lower sub-range in total represents the total operating voltage variation range.

14. Method according to claim 11, comprising:
settably controlling said one or more currents conducted through said irradiating components in dependence of said current supply voltage, wherein said settable controlling is obtained by settable current target values in dependence of said current supply voltage.

15. Method according to claim 11, comprising:
settably controlling said power generators exercising said control over said currents in dependence of said current supply voltage to obtain a total luminosity of irradiation substantially independent from said current supply voltage of said power source.

16. Method according to claim 10, wherein said method is operated by a portable electric device having a processing unit (CPU/MPU); and being equipped with at least an IR transmitter enabling for IR communications, wherein said IR irradiating components are IR light emitting diodes (LEDs).
